(19) United States
(12) Patent Application Publication
(10) Pub. No.: US 2011/0046808 A1
(43) Pub. Date: Feb. 24, 2011

(54) CONTROLLER AND SYSTEM INCLUDING A CONTROLLER FOR DETECTING A FAILURE THEREOF

(76) Inventors: JOE M. KELLIS, Weaverville, NC (US); LAWRENCE B. FARR, Asheville, NC (US)

Correspondence Address: Martin J. Moran;Eaton Electrical, Inc., 1000 Cherrington Parkway, Moon Township, PA, 15108, US

(21) Appl. No.: 12/543,587

(22) Filed: Aug. 19, 2009

(51) Int. Cl. G06F 1/28

(52) U.S. Cl. 700/293; 700/292

(57) ABSTRACT

A controller for a load includes separable contacts, an operating mechanism structured to open and close the separable contacts, a processor circuit cooperating with the operating mechanism to open and close the separable contacts, and an output controlled by the processor circuit. The output is structured to cause a remote circuit interrupter to open a power circuit electrically connected in series with the separable contacts. The processor circuit is structured to detect failure of the controller to control the load and activate the output.

### BACKGROUND

1. Field

The disclosed concept pertains generally to electrical switching apparatus and, more particularly, to controllers. The disclosed concept also relates to systems including a controller.

2. Background Information

Contactors are employed, for example and without limitation, in starter applications to switch on/off a load as well as to protect a load, such as a motor or other electrical device, from current overloads. Contactors are used as electrical switching apparatus and incorporate fixed and movable contacts that when closed, conduct electric power.

For example, three-pole, low voltage contactors have three contact assemblies, one contact assembly for each phase or pole of a three-phase electrical device. Each contact assembly can include, for example, a pair of stationary contacts and a moveable contact. One stationary contact is a line side contact and the other stationary contact is a load side contact. The moveable contact is controlled by an actuating assembly comprising an armature and magnet assembly, which is energized by a coil to move the moveable contact to form a bridge between the stationary contacts. When the moveable contact is engaged with both stationary contacts, current is allowed to travel from the power source or line to the load, motor or other electrical device. When the moveable contact is separated from the stationary contacts, an open circuit is created and the line and load are electrically isolated from one another.

Generally, a single coil is used to operate a common carrier for all three contact assemblies. As a result, the low voltage contactor is constructed such that whenever a fault condition or switch open command is received in any one pole or phase of the three-phase input, all the contact assemblies of the contactor are opened in unison. Simply, the contact assemblies are controlled as a group as opposed to being independently controlled.

Medium voltage contactors generally include air gap, insulating gas and vacuum varieties. For example, vacuum contactors interrupt an electrical arc within a vacuum.

A single-phase vacuum contactor, for example, includes a vacuum bottle having a suitable highly evacuated vacuum maintained therein, an operating mechanism, an alternating current (AC) power line terminal and a load terminal. For example, a fixed contact and a movable contact are contained within the vacuum bottle and are electrically connected to the line terminal and a movable bottle stem, respectively. The load terminal of the contactor is electrically connected by a shunt to the bottle stem which protrudes from the bottle. Movement of the bottle stem away from the bottle moves the movable contact away from the fixed contact and, thus, separates the contacts in an open position. The operating mechanism includes, for example, a T-shaped crossbar which is rotatable about a bearing, and a coil having an armature which is responsive to the coil and attached to the crossbar in order to rotate the crossbar. The T-shaped crossbar has a kick-out arm and a pivot plate arm.

Examples of medium voltage or vacuum contactors including a number of poles are disclosed in U.S. Pat. Nos. 5,559,426; 4,559,511; 4,544,817; 4,504,808; 4,485,366; 4,479,042; and 4,247,745.

During maintenance of known vacuum contactors to replace a number of failed components, coils, coil magnets, armature stop assemblies, auxiliary contact assemblies, vacuum interrupters and/or other components might fail and/or be incorrectly replaced. Such failures and/or incorrect replacements might not be apparent to the user until after the vacuum contactor suffers a subsequent failure (e.g., without limitation, contact welding). For example, a kick-out spring can break, contactor latch mechanisms can fail to unlatch, or a sticky substance can get between an armature plate and a coil core, thereby not allowing the kick-out spring to open the vacuum interrupters and interrupt the load current. In this instance, the vacuum contactor can no longer protect the load or its power circuit. Hence, there is a need to verify contactor health during maintenance before the contactor is installed in a power system.

When a vacuum interrupter looses vacuum, it can no longer interrupt current. In a three-phase motor circuit, the loss of vacuum in one of the three vacuum interrupters does not mean that the vacuum contactor cannot interrupt power to the motor, since the other two vacuum interrupters can still operate. However, when a second vacuum interrupter looses vacuum, the two failed vacuum interrupters continue to arc. This will break the ceramic enclosures of the two failed vacuum interrupters, which, in turn, can cause phase-to-phase arcing and arcing to the enclosure. At the same time, the motor can be single-phased and might be damaged, burn up or otherwise be destroyed before fuses or other upstream protective devices interrupt the failure.

During maintenance cycles, a vacuum contactor is removed from its enclosure and each vacuum interrupter is subjected to a power potential withstand test (e.g., high-pot) level (e.g., without limitation, 16,000 AC volts for one minute for a 7,200 volt contactor). The vacuum contactor fails if there is an arc between the moving and stationary contacts inside the vacuum interrupter. This is the only known way that a vacuum loss is detected after a vacuum interrupter is installed in a vacuum contactor. This is time consuming, expensive, requires bulky, expensive equipment and skilled technicians, and can only occur during extended maintenance down times. As a result, many vacuum losses go undetected until a second vacuum interrupter fails. This event always results in the loss of the vacuum contactor, usually a motor starter, and all too often the motor.

Referring to FIG. 1, an armature stop assembly 2 adjusts the air gap 4 between an armature plate 6 and a core 8 of a coil 10. The air gap 4 is adjusted during initial factory testing. If the armature stop assembly 2 breaks, becomes worn, or if there is a loosening of hardware, then this results in an increase in the pick-up voltage requirement of the coil 10. This can cause the vacuum contactor to close relatively slowly, which can lead to contact welding. If the main contacts 12 weld, the motor starter cannot turn off the voltage and current going to the motor. If one vacuum interrupter, such as 14, welds and the other two vacuum interrupters (not shown) lose their contact gap 11, then there is a loss of ability to interrupt current, because they are on a common assembly. This results in arcing between the unwelded contacts, resulting in a rupture of the vacuum envelope of the vacuum interrupter 14. The rupture of the vacuum envelope leads to loss of the vacuum contactor, usually loss of a motor starter (not shown), and sometimes loss of a motor (not shown).

A coil circuit, which includes the coil 10, is an important aspect of closing and holding closed the vacuum contactor. Two example failure modes of the coil 10 include a broken lead and shorted windings. If the coil 10 is healthy, then the vacuum contactor will close, for example, in about 66 milliseconds. A coil circuit failure in an autotransformer circuit often leads to a failure of the autotransformer.

Coil magnet assemblies, which include the armature plate 6 and the coil core 8, must be aligned properly at factory assembly for the vacuum contactor to have a relatively low drop-out voltage in the range of, for example, 45 to 60 volts. Each vacuum contactor has a known drop-out voltage after factory setup, which is independent of vacuum loss or atmospheric pressure. A relatively low drop-out voltage is not possible if the coil magnet assembly is not aligned properly, if the alignment is changed because of worn, dirt or magnetic material in the gap 4 between the armature plate 6 and the coil core 8, or if there is a loosing of hardware resulting from the shock of the contactor closing. Sticky substances between the armature plate 6 and the coil core 8 will result in higher coil opening voltages. A relatively high drop-out voltage causes motor starter shutdowns during brownouts, voltage dips during motor starting, recloser operations, and faults on the network.

Some vacuum contactors include an optional mechanical latch attachment or assembly 16, which makes the vacuum contactor act like a circuit breaker. The closing coil 10 pulls an armature 17 closed and a latch spring 18 pushes the latch assembly 16 into place, thereby preventing the vacuum contactor from dropping open when the closing coil 10 is de-energized. Then, to open the vacuum contactor, a trip coil 20 is energized, thereby pulling the latch assembly 16 away from the armature 17 and allowing a kick-out spring 22 to open the vacuum contactor.

Auxiliary contacts, such as 24, are used to determine if the vacuum contactor is closed or open. When the auxiliary contacts 24 operate, they normally reflect the open or closed status of the main contacts 12. The auxiliary contacts 24 are typically set to change state from open to closed at the same time the main contacts 12 touch, but are not yet sealed in. In other words, the auxiliary contacts 24 are intended to report the open or closed position of the main contacts 12. However, due to wear, breakage, loosing of hardware, conductor breakage, or a conductor coming loose or being improperly installed during maintenance, the auxiliary contacts 24 can give the wrong indication of the location of the main contacts 12.

Various commissioning tests are performed on medium voltage contactors before they are energized for the first time. Some non-limiting examples of these commissioning tests are discussed below.

A power frequency dielectric withstand (or AC high-pot) test tests the vacuum contactor. An example test voltage is two times line-to-line voltage plus 2000 VAC for 60 seconds with a disruptive discharge (spark over) being a failure. For example, for the International Electrotechnical Commission (IEC), the voltage is 20,000 volts for 7.2 kV class equipment.

A vacuum integrity test provides an AC high-pot across the vacuum interrupters. The test voltage varies with the particular vacuum interrupter manufacturer. For example, the voltage can be 16,000 VAC for 60 seconds with a disruptive discharge being a failure.

The proper operation of the auxiliary contacts 24 are checked by closing the vacuum contactor by hand and verifying that the auxiliary contacts 24 close at the same time that the main contacts 12 of the vacuum interrupter 14 close.

The vacuum contactor is closed using auxiliary control power and the contact resistance is measured. For example, this is mandatory for IEC, but optional for UL, CSA and NEMA.

All power connections are mechanically checked for tightness. This is done with a torque wrench to the manufacturer's specifications.

All electrical control conductors are checked to verify that they are in place and that the electrical connections are suitably tight.

The placement of the vacuum contactor in the cell of an enclosure is checked and all power connections are verified to be secure and, if bolted, are torqued to the manufacturer's specifications. Also, all control connections are verified to be secure.

The mechanical interlocks, if any, are checked to determine if they are in working order.

Known motor protective relays initiate a contactor opening when the protective relay detects a problem (e.g., without limitation, I²t; ground fault) with a motor and declares a trip. If single-phase or three-phase current continues to flow, then, after a suitable time delay, the motor protective relay energizes an output that can be configured to open an upstream circuit interrupter.

It is known that an automatic control circuit (e.g., a programmable logic controller (PLC); a distributed control system (DCS)), tells a contactor to open under certain conditions.

There is room for improvement in controllers.

There is further room for improvement in systems including controllers.

### SUMMARY

It is believed that known technology does not know if a control circuit has told a contactor to open and that the contactor did not interrupt current to the load.

It is also believed that it is not known that if a PLC, a DCS or a control circuit tells a contactor to open and current continues to flow that a motor protective relay will energize an output that can be configured to open an upstream circuit interrupter.

It is believed that it is not known that if a contactor fails to open when a corresponding control circuit calls for the contactor to open and it does not open or if current continues to flow, then an upstream circuit interrupter will be told to open the corresponding load.

In accordance with aspects of the disclosed concept, when a controller opening is initiated, regardless of the reason, and current (e.g., single-phase or three-phase current) continues to flow, a controller output is activated that is structured to cause a remote circuit interrupter to open a power circuit electrically connected in series with the separable contacts of the controller. Also, in accordance with further aspects of the disclosed concept, if the controller is determined to be open, then the separable contacts of the controller will be reclosed (e.g., without limitation, to eliminate arcing in three-phase vacuum interrupters and resulting damage to the contactor, motor starter and motor control center, and single-phasing of the motor and resulting damage thereto).

These needs and others are met by embodiments of the disclosed concept, in which a controller detects a number of failures thereof.

In accordance with one aspect of the disclosed concept, a controller for a load comprises: separable contacts; an operating mechanism structured to open and close the separable contacts; a processor circuit cooperating with the operating mechanism to open and close the separable contacts; and an output controlled by the processor circuit, the output being structured to cause a remote circuit interrupter to open a power circuit electrically connected in series with the separable contacts, wherein the processor circuit is structured to detect failure of the controller to control the load and activate the output.

The processor circuit may comprise a processor, a memory, a first sensor structured to sense voltage operatively associated with the separable contacts and a second sensor structured to sense current flowing through the separable contacts; and the processor may be structured to store in the memory a cause of the failure of the controller to open or interrupt current, a time and date of the failure of the controller to open or interrupt current, a voltage applied to the separable contacts, and a current flowing through the separable contacts.

The operating mechanism may comprise auxiliary contacts; the processor circuit may comprise a processor, a first sensor structured to sense voltage operatively associated with the separable contacts, a second sensor structured to sense current flowing through the separable contacts, and a routine structured to be executed by the processor whenever the separable contacts are intended to be open; and the routine may be structured to determine that a voltage is applied to the separable contacts, that a current is flowing through the separable contacts, that the auxiliary contacts indicate that the separable contacts are closed, and responsively reclose the separable contacts and activate the output.

The operating mechanism may comprise auxiliary contacts; the processor circuit may comprise a processor, a first sensor structured to sense voltage operatively associated with the separable contacts, a second sensor structured to sense current flowing through the separable contacts, and a routine structured to be executed by the processor whenever the separable contacts are intended to be open; and the routine may be structured to determine that a voltage is applied to the separable contacts, that a current is flowing through the separable contacts, that the auxiliary contacts indicate that the separable contacts are open, and responsively activate the output.

The processor circuit may comprise a processor, a first sensor structured to sense voltage operatively associated with the separable contacts, a second sensor structured to sense current flowing through the separable contacts, and a routine structured to be executed by the processor whenever the separable contacts are intended to be closed; and the routine may be structured to determine that a voltage is applied to the separable contacts, a current is flowing through the separable contacts, the auxiliary contacts are open, and responsively indicate a failure of the auxiliary contacts.

The routine may be further structured to be executed by the processor whenever the separable contacts are intended to be opened, and to determine that a current is not flowing through the separable contacts, the auxiliary contacts are closed, and responsively indicate a failure of the auxiliary contacts.

The processor circuit may comprise a processor, a sensor structured to sense current flowing through the separable contacts, and a routine structured to be executed by the processor whenever the separable contacts are intended to be closed; and the routine may be structured to determine that a current is not flowing through the separable contacts, the auxiliary contacts are open, and responsively indicate a failure of the operating mechanism to close the separable contacts.

As another aspect of the disclosed concept, a controller comprises: separable contacts; an operating mechanism comprising a number of coils structured to open and close the separable contacts; a processor cooperating with the number of coils to open and close the separable contacts; an output controlled by the processor; and a control circuit controlled by the processor, wherein the control circuit is structured to cause the number of coils to open and close the separable contacts, and wherein the processor is structured to detect failure of the separable contacts and activate the output.

The number of coils may be a coil; the operating mechanism may further comprise auxiliary contacts structured to indicate an open state or a closed state of the separable contacts as controlled by the coil; the processor may include a memory having a first predetermined value corresponding to a first voltage at which the coil is expected to close the separable contacts and a second predetermined value corresponding to a second voltage at which the coil is expected to open the separable contacts; the control circuit may be structured to apply a voltage to the coil; and the processor may further include a routine structured to activate the output if the applied voltage to the coil is greater than the first predetermined value when the separable contacts are closed or if the applied voltage to the coil is greater than the second predetermined value when the separable contacts are opened.

As another aspect of the disclosed concept, a controller comprises: separable contacts; an operating mechanism comprising a coil structured to open and close the separable contacts and auxiliary contacts structured to indicate an open state or a closed state of the separable contacts; a first sensor structured to sense voltage operatively associated with the separable contacts; a second sensor structured to sense current flowing through the separable contacts; a processor cooperating with the coil to open and close the separable contacts; and an output controlled by the processor, wherein the processor is structured to detect failure of the separable contacts or the auxiliary contacts and activate the output.

The processor may comprise a routine structured to be executed by the processor whenever the separable contacts are intended to be closed; and the routine may be structured to determine from the sensed voltage that a voltage is applied to the separable contacts and from the sensed current that a current is flowing through the separable contacts, and that the auxiliary contacts indicate that the separable contacts are open, and responsively indicate at the output a failure of the auxiliary contacts.

The processor may comprise a routine structured to be executed by the processor whenever the separable contacts are intended to be closed; and the routine may be structured to determine from the sensed current that a current is not flowing through the separable contacts, and that the auxiliary contacts indicate that the separable contacts are open, and responsively indicate at the output a failure to close the separable contacts.

The processor may comprise a routine structured to be executed by the processor whenever the separable contacts are intended to be open; and the routine may be structured to determine from the sensed current that a current is flowing through the separable contacts, and that the auxiliary contacts indicate that the separable contacts are open, and responsively reclose the separable contacts and indicate at the output a failure to interrupt the current.

The processor may comprise a routine structured to be executed by the processor whenever the separable contacts are intended to be open; and the routine may be structured to determine from the sensed current that a current is flowing through the separable contacts, and that the auxiliary contacts indicate that the separable contacts are closed, and responsively indicate at the output a failure of the operating mechanism.

As another aspect of the disclosed concept, a system for control of a load comprises: a controller comprising: separable contacts, an operating mechanism structured to open and close the separable contacts, a processor cooperating with the operating mechanism to open and close the separable contacts, and an output controlled by the processor, wherein the processor is structured to detect failure of the controller to control the load and activate the output; a circuit interrupter upstream of the controller and responsive to the output thereof, and a power circuit electrically connected in series with the separable contacts, wherein the circuit interrupter is structured to open the power circuit electrically connected in series with the separable contacts responsive to the activated output of the controller.

### BRIEF DESCRIPTION OF THE DRAWINGS

A full understanding of the disclosed concept can be gained from the following description of the preferred embodiments when read in conjunction with the accompanying drawings in which:

FIG. 1 is a simplified block diagram of a contactor coil, an operating mechanism and a vacuum interrupter.

FIG. 2 is a block diagram of a three-pole medium voltage contactor in accordance with embodiments of the disclosed concept.

FIG. 3 is a flow chart of a contactor health calibration routine for the processor of FIG. 2.

FIG. 4 is a flow chart of a contactor health test routine for the processor of FIG. 2.

FIGS. 5A-5B form a flow chart of an auxiliary contact and coil health test routine for the processor of FIG. 2.

FIG. 6 is a block diagram in schematic form of the contactor coil control circuit of FIG. 2.

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the term “activate” means to make active; to cause a practical operation or result; or to cause an output to assume an active state from an inactive state.

As employed herein, the term “low voltage” shall mean any voltage that is less than about 600 V_{RMS}.

As employed herein, the term “medium voltage” shall mean any voltage greater than a low voltage and in the range from about 600 V_{RMS} to about 52 kV_{RMS}.

As employed herein, the term “controller” means the combination of a contactor and a protective relay.

As employed herein, the term “protective relay” can include, for example and without limitation, a number of current and/or voltage sensors, a processor circuit, and a control circuit to open and close a contactor. The protective relay and/or current and/or voltage sensors can be part of or be separate from a contactor.

As employed herein, the term “contactor” includes, for example and without limitation, a low voltage contactor; a medium voltage contactor; or an electrically operated low or medium voltage circuit breaker. A contactor can include, for example and without limitation, a number of separable contacts and an operating mechanism. Contactors and circuit breakers may also include auxiliary contacts.

The disclosed concept is described in association with magnetically closed contactors, such as three-pole vacuum contactors, although the disclosed concept is applicable to a wide range of controllers having any number of poles. For example and without limitation, aspects of the disclosed concept can advantageously be employed with electrically operated low or medium voltage circuit breakers.

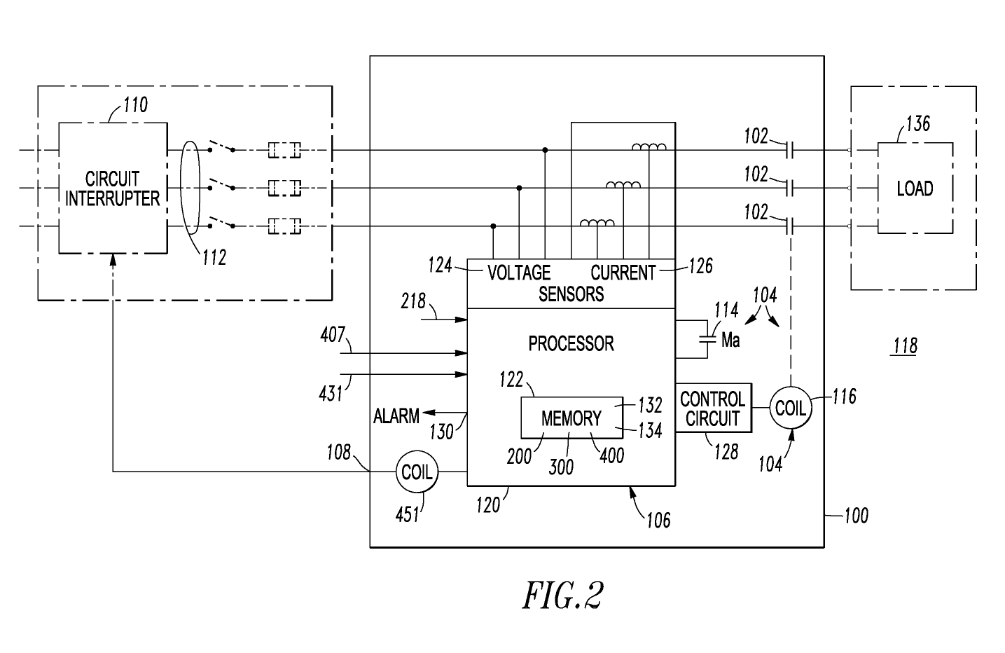

Referring to FIG. 2, an example three-pole controller or contactor 100 is shown. In this example, a protective relay formed by processor circuit 106, sensors 124,126 and control circuit 128 is part of the controller or contactor 100. It will be appreciated, however, that such a protective relay can be separate from a contactor including, for example, separable contacts 102, operating mechanism 104 and, optionally, auxiliary contacts 114.

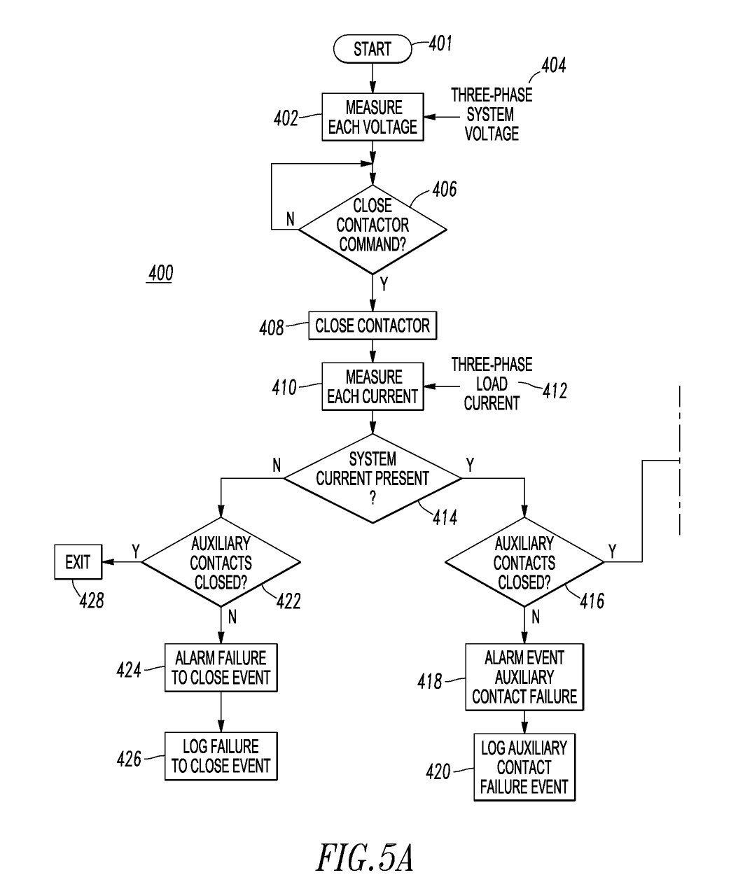

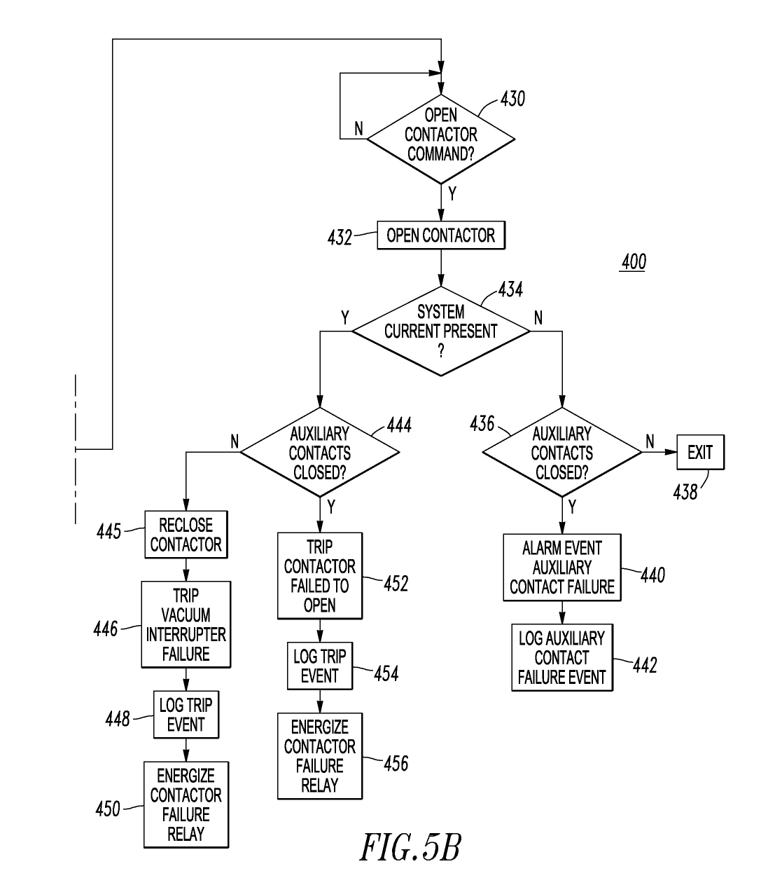

The example three-pole controller or contactor 100 includes the separable contacts 102, the operating mechanism 104 (e.g., such as the example coil 116) structured to open and close the separable contacts 102, the processor circuit 106 cooperating with the operating mechanism 104 to open and close the separable contacts 102, and an output 108 controlled by the processor circuit 106. In the example of FIG. 2, the output 108 is structured to cause a remote circuit interrupter 110 (shown in phantom line drawing) to open a power circuit 112 (shown in phantom line drawing) electrically connected in series with the separable contacts 102 of the contactor 100. As will be discussed in greater detail, below, in connection with FIGS. 5A-5B, the processor circuit 106 is structured to detect failure of the contactor 100 to control the load 136 and activate the output 108.

### EXAMPLE 1

As is conventional, the example operating mechanism 104 can include auxiliary contacts 114 (Ma) structured to indicate an open state or a closed state of the separable contacts 102 as controlled by the coil 116. Although one coil 116 is shown, the disclosed concept is applicable to contactors having any number of coils (e.g., without limitation, a close coil; an open coil; a mechanical latch coil).

### EXAMPLE 2

A system 118 includes the remote circuit interrupter 110, the power circuit 112 and the contactor 100. The circuit interrupter 110 is upstream of the contactor 100 and responsive to the output 108 thereof. The circuit interrupter 110 is structured to open the power circuit 112 electrically connected in series with the separable contacts 102 responsive to the activated output 108 of the contactor 100.

### EXAMPLE 3

The example processor circuit 106 can include a processor 120, a memory 122, a first sensor 124 structured to sense voltage operatively associated with the separable contacts 102, and a second sensor 126 (e.g., without limitation, a number of Rogowski coils) structured to sense current flowing through the separable contacts 102. The processor circuit 120 cooperates with the coil 116 to open and close the separable contacts 102. The processor circuit 120 or operating mechanism 104 preferably includes the control circuit 128 controlled by the processor 120. The control circuit 128 is structured to cause the coil 116 to open and close the separable contacts 102. The processor 120 is structured to detect failure of the separable contacts 102 (e.g., a number of vacuum interrupters) and/or the auxiliary contacts 114 and activate the output 108 and/or an alarm output 130.

The processor circuit 106, the control circuit 128 and the sensors 124,126 may or may not be part of the contactor 100. The coil 116 and the auxiliary contacts 114 are part of the contactor 100.

### EXAMPLE 4

A failure of the contactor 100 to control the load 136 can be a failure of a component of the contactor 100, such as a number of vacuum interrupters which form the separable contacts 102 of the contactor 100.

### EXAMPLE 5

The contactor 100 can be a medium voltage vacuum contactor.

### EXAMPLE 6

A failure of the contactor 100 to control the load 136 can be a failure of a component of the contactor 100, such as the operating mechanism 104, which includes the auxiliary contacts 114.

### EXAMPLE 7

The memory 122 can include a first predetermined value 132 corresponding to a first voltage at which the coil 116 is expected to close the separable contacts 102, and a second predetermined value 134 corresponding to a second voltage at which the coil 116 is expected to open the separable contacts 102.

### EXAMPLE 8

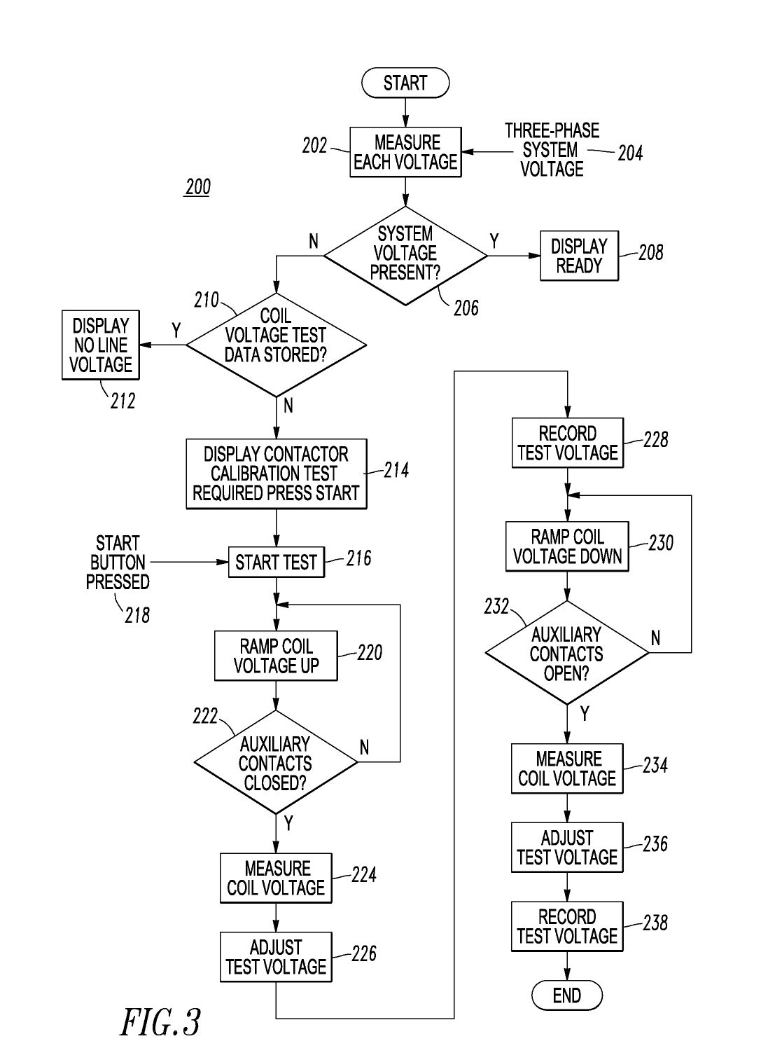

During initial setup and test of the contactor 100, it is tested (see Example 10, below, in connection with FIG. 3) to verify “initially installed” pick-up and drop-out voltages. Such test can be accomplished by varying the output of the control circuit 128, which can be, for example and without limitation, a pulse-width modulated (PWM) coil control circuit, to determine at what pick-up voltage level the contactor 100 closes and at what drop-out voltage level the contactor 100 opens.

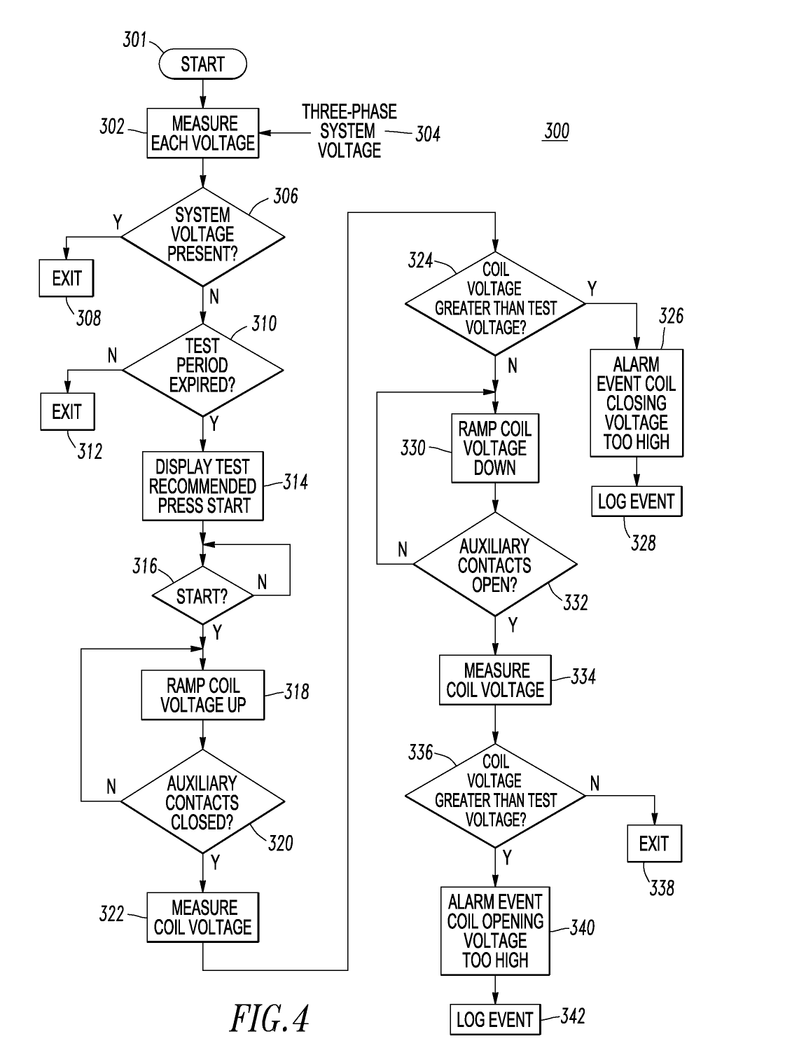

During or following subsequent maintenance (e.g., without limitation, during a system maintenance shutdown; during or following maintenance of a contactor), the contactor processor 120 varies (see Example 11, below, in connection with FIG. 4) the output of the PWM coil control circuit 128 and determines at what pick-up voltage level the contactor 100 closes and at what drop-out voltage level the contactor 100 opens. If either of these voltages is significantly different from the corresponding “initially installed” pick-up and drop-out voltages, respectively, then, for example, a suitable alarm message or other suitable annunciation can be output at output 130. This informs maintenance personnel or another operator or user which of the voltages has changed and, optionally, can suggest a number of additional tests to isolate the source of the possible problem.

### EXAMPLE 9

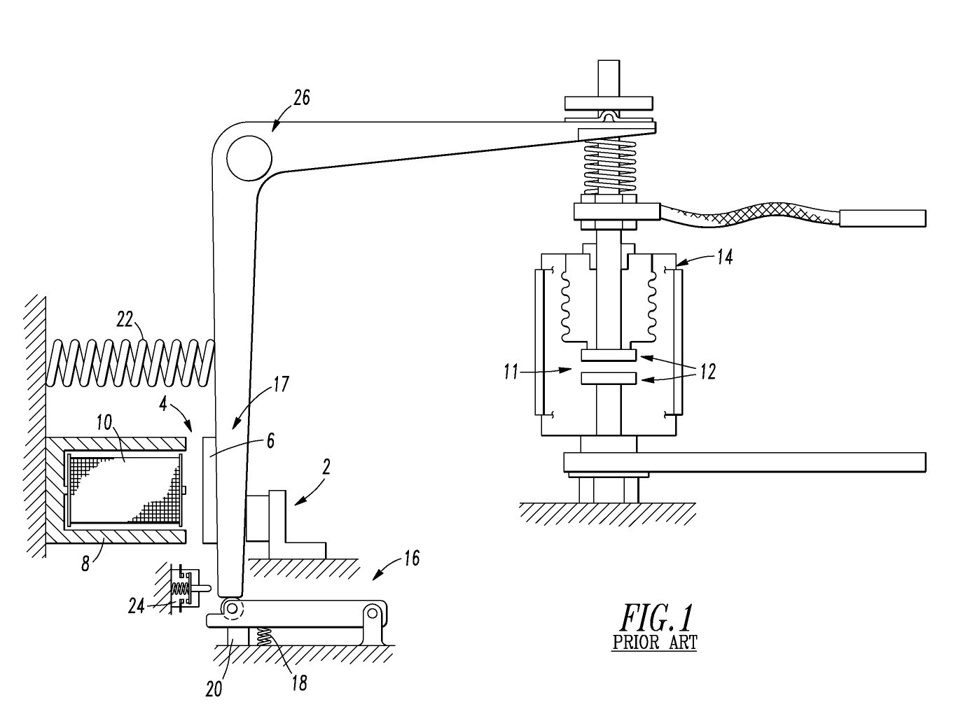

Various factors affect detection of loss of vacuum in one vacuum interrupter. For example, atmospheric pressure at sea level is 14.7 pounds per square inch (PSI). The bellows of a 400 A, 7.2 kV vacuum interrupter is about 2 square inches. To pull the vacuum interrupter open requires about 30 pounds of force at sea level. Vacuum contactors (see, e.g., the contactor 100 of FIG. 2) used to start three-phase motors (see, e.g., the three-phase load 136 of FIG. 2) have three vacuum interrupters (see, e.g., the separable contacts 102 of FIG. 2) operated by a common shaft assembly (see, e.g., common shaft assembly 26 of FIG. 1). These forces are counterbalanced by a kick-out spring (see, e.g., kick-out spring 22 of FIG. 1) that holds the three vacuum interrupters open when the contactor coil 116 is de-energized.

At an altitude of 3000 feet, the atmospheric pressure is 13.2 PSI, and at an altitude of 9000 feet, the atmospheric pressure is 10.3 PSI. It is, therefore, necessary in this example to compensate for the final elevation.

Under different weather conditions, the atmospheric pressure can vary about ±3% between normal high pressure and normal low pressure conditions. However, in a hurricane, the atmospheric pressure can drop by up to −7%.

The pick-up voltage, which is the voltage required to close and seal in a vacuum interrupter, can vary from vacuum contactor to vacuum contactor from a high of about 75 volts to a low of about 60 volts. This is a function of many variables and tolerances in the manufacture of the vacuum contactor. After being assembled, the pick-up voltage does not change. Hence, it is necessary, in this example, to compensate for the vacuum contactor original pick-up voltage.

Another variable is how many vacuum interrupters have a full vacuum. A vacuum contactor with three good vacuum interrupters takes, for example, 65 volts to close. For the loss of vacuum in one vacuum interrupter, the vacuum contactor requires, for example, 80 volts to close. With the loss of vacuum in two vacuum interrupters, the vacuum contactor requires, for example, 100 volts to close.

### EXAMPLE 10

Referring to FIG. 3, a contactor health calibration routine 200 is shown. For example, the pick-up voltage can be calibrated during original field commissioning of the contactor 100 of FIG. 2. For a vacuum contactor, it is checked and verified for vacuum integrity, auxiliary contact operation, proper operation of latch mechanisms (see, e.g., latch assembly 16 of FIG. 1), if supplied, and for the armature stop assembly (see, e.g., armature stop assembly 2 of FIG. 1), being in the correct location. For example, if the armature stop assembly comes loose, then this can increase the coil voltage required to close the contactor 100. This condition can be checked in the same manner as for a condition of a loss of vacuum in the vacuum interrupter.

The routine 200 is performed when the vacuum contactor 100 is installed and energized with control power. Prior to this, suitable commissioning tests are performed on the vacuum contactor 100, and the vacuum contactor is installed in a corresponding cell of a suitable enclosure.

First, at 202, the processor 120 of FIG. 2 measures each of the three-phase line voltages 204 using the voltage sensors 124. Next, at 206, if any line voltage is present, then the routine 200 displays a suitable message (e.g., “Ready”) on output 130 (e.g., a display) before exiting. “Ready” means that when the contactor 100 is closed, the corresponding load 136 will be energized. Otherwise, at 210, it is determined if there is no previously recorded coil voltage test data 132,134 (e.g., without limitation, null values are initially stored in the memory 122. If not, then at 214, the routine 200 displays a suitable message (e.g., “contactor calibration test required press start” on the output 130. Otherwise, at 212, the routine 200 displays a suitable message (e.g., “no line voltage”) on the output 130 before exiting.

After 214, at 216, activation of a start button 218 being pressed is checked. This test is only conducted on an un-energized circuit because the contacts are closing slowly and welding may result. If activated, then at 220, the processor 120 increases the coil voltage by increasing a PWM on-time ratio to the coil control circuit 128. Then, at 222, it is determined if the auxiliary contacts 114 are closed. If not, then 220 is repeated. Otherwise, at 224, the coil voltage is measured or calculated (e.g., from the PWM on-time ratio to the coil control circuit 128). Next, at 226, the processor 120 adjusts the value to compensate for expected changes in atmospheric pressure and records this as the closing coil voltage 132 not to be exceeded, at 228. Next, at 230, the processor 120 begins to lower the coil voltage by adjusting the PWM on-time ratio. Then, at 232, it is determined if the auxiliary contacts 114 are open. If not, then 230 is repeated. Otherwise, at 234, the processor 120 calculates/measures the coil voltage and, at 236, adjusts the value to compensate for expected changes in low control circuit voltage (e.g., without limitation, corresponding to a drop-out voltage in the range of 45 to 60 volts) and records this, at 238, as the opening coil voltage 134 not to be exceeded before the routine 200 exits.

At 224 and 234, although the processor 120 could measure the coil voltage, it is simpler to know the percentage on-time of the PWM on-time ratio and calculate the voltage. When the auxiliary contacts 114 close or open, the processor 120 knows the percentage on-time and, therefore, the voltage applied to the coil 116. Hence, the applied coil voltage increases/decreases responsive to the routine 200 increasing/decreasing the PWM on-time ratio to the PWM control circuit 128.

At 226 and 236, the most the atmospheric pressure will normally change in any one area is about ±3%. The percentage on-time is multiplied by a suitable predetermined value (e.g., without limitation, 1.10; a value to limit the number of false trips and/or alarms; any suitable value) to arrive at the corresponding voltage 132,134 not to be exceeded. This also compensates for changes in source voltage. The processor 120 stores the resulting values 132,134 in the memory 122 to be recalled later by the routine 300 of FIG. 4.

### EXAMPLE 11

Referring to FIG. 4, the contactor health test routine 300 is shown. This routine 300 is started, at 301, on a suitable periodic basis (e.g., without limitation, six months; one year; any suitable time). Then, at 302, the processor 120 measures each of the three-phase line voltages 304 from the voltage sensors 124 of FIG. 2. Next, at 306, if any line voltage is present, then the routine 300 exits at 308. Otherwise, at 310, it is determined if a predetermined test period (e.g., without limitation, six months; any suitable time) has expired. If not, then the routine 300 exits at 312. Otherwise, at 314, a suitable message or other suitable indication is output (e.g., without limitation, “Contactor Health Test Recommended Press Start”) on the output 130 (e.g., without limitation, display). Next, at 316, activation of the start button 218 of FIG. 2 is checked. If activated, then at 318, the processor 120 increases the coil voltage by increasing a PWM on-time ratio to the coil control circuit 128. Then, at 320, it is determined if the auxiliary contacts (Ma) 114 are closed. If not, then 318 is repeated. Otherwise, at 332, the coil voltage is measured (e.g., as was done at 224,234 of FIG. 3). Next, at 324, if the measured coil voltage is greater than the stored closing coil voltage 132 in the memory 122 of FIG. 2, then at 326, an alarm is activated (e.g., without limitation, “Coil Closing Voltage Too High”) at output 130 and this event is logged at 328 before the routine 300 exits. For example, a relatively high coil closing voltage can be caused by loss of vacuum or a loose armature stop.

On the other hand, if the measured coil voltage is less than or equal to the stored closing coil voltage 132, then at 330, the processor 120 decreases the coil voltage by decreasing the PWM on-time ratio to the coil control circuit 128. Next, at 332, it is determined if the auxiliary contacts (Ma) 114 are open. If not, then 330 is repeated. Otherwise, at 334, the coil voltage is measured (e.g., as was done at 224,234 of FIG. 3). Next, at 336, if the measured coil voltage is greater than the stored opening voltage 134, then at 340, an alarm is activated (e.g., without limitation, “Coil Opening Voltage Too High”) at output 130 and this event is logged at 342 before the routine 300 exits. For example, a relatively high coil opening voltage can be caused by a misadjusted armature plate or loss of vacuum. Otherwise, if the measured coil voltage is less than or equal to the stored opening voltage 134, then the routine 300 exits at 338.

At 334, the drop-out voltage is measured by first closing the contactor 100, at 318,320, after which the voltage to the coil 116 is decreased steadily, at 330, until the auxiliary contacts 114 open at 332. The drop-out voltage is then compared at 336 to the value 134 calibrated at field commissioning of the contactor 100. The drop-out voltage is calibrated during original field commissioning of the contactor 100, after it has been checked and verified for proper alignment of the coil magnet assemblies and operation of the auxiliary contacts 114.

### EXAMPLE 12

Referring to FIGS. 5A-5B, an auxiliary contact and coil health test routine 400 is shown. This routine 400 is run, at 401, each time the contactor 100 of FIG. 2 closes. For example, potential problems with the coil 116 can be detected when the auxiliary contacts (Ma) 114 do not close and/or the load current does not start flowing.

First, at 402, the processor 120 measures each of the three-phase line voltages 404 using the voltage sensors 124 of FIG. 2. Next, at 406, the processor 120 checks for a close contactor command 407 (FIG. 2). If the close command 407 is active and all system voltages are present, then at 408, the processor 120 commands the contactor 100 to close by providing a suitable close PWM on-time value to the control circuit 128. If all three system voltages are not present, then the contactor 100 will not be allowed to close and an alarm condition will be declared (e.g., “No Line Voltage”). Otherwise, 406 is repeated. Next, at 410, the processor measures the three-phase load current 412 using the three-phase current sensors 126. Next, at 414, it is determined if load current is flowing for all phases. If so, then at 416, it is determined if the auxiliary contacts (Ma) 114 are closed. If not, then an alarm event is declared (e.g., “Alarm Auxiliary Contact Failure”) at 418 and is logged at 420, before the routine 400 exits. For example and without limitation, this and other alarms and/or trips remain displayed until reset.

Step 414 essentially considers from the sensed current whether the contactor 100 is closed. The example contactor 100 has three vacuum interrupters operating as a gang and closing at the same time. The system voltages were considered at 402. If any current flows, then it is considered that the contactor 100 has closed. Hence, for the example three-phase circuit, normally all three phase currents are flowing. If only one current is flowing, then there is a ground fault and the processor 120 jumps from the routine 400 and looks at a higher order condition of a ground fault and trips. If only two currents are flowing, then the processor 120 jumps from the routine 400 and deals with a higher priority condition of single phasing and trips. Hence, normally, the processor 120 continues with the routine 400 when there are all three currents flowing. It will be appreciated, however, that the disclosed concept can be applied to contactors having any number of phases.

On the other hand, with the example system voltages for all phases being present, and if none of the currents for the three-phases are flowing, then at 422, it is determined if the auxiliary contacts (Ma) 114 are closed. If not, then an alarm event is declared (e.g., “Alarm Failure To Close”) at 424 and is logged at 426, before the routine 400 exits. For example and without limitation, this event can be caused by a mechanical interlock (not shown) blocking (e.g., without limitation, if improperly adjusted) the contactor 100 and preventing it from closing or by a coil failure. Otherwise, at 428, if the auxiliary contacts 114 are properly closed, then the routine 400 exits.

At 416, if the auxiliary contacts 114 are closed, then at 430, the processor 120 checks for an open contactor command 431 (FIG. 2). If the open command 431 is active, then at 432, the processor 120 commands the contactor 100 to open by removing the PWM on-time value from the control circuit 128. Otherwise, 430 is repeated. Next, at 434, all of the system voltages are present, but if none of the sensed load currents are flowing, then at 436, it is determined if the auxiliary contacts (Ma) 114 are closed. If not, then at 438, the routine 400 exits. Otherwise, an alarm event is declared (e.g., “Auxiliary Contact Failure”) at 440 and is logged at 442, before the routine 400 exits.

At the “no” branch of 434, it is determined that none of the load currents are flowing and that the contactor 100 interrupted all of the load currents. However, at the “yes” branch of 434, at least one of the sensed load currents is flowing. In this instance, as will be explained in connection with 445, the example three-phase contactor 100 is reclosed because there is arcing in at least two of the example vacuum interrupters. Here, the motor starter (not shown) has lost control of the load and needs the upstream circuit interrupter 110 to interrupt the power circuit 112 because the contactor 100 cannot. It will be appreciated, however, that the disclosed concept can be applied to contactors having any number of phases. Unlike step 414, steps 434 and 444 through 450 or 444 through 456 take priority over other routines (not shown) that deal with a ground fault (one current flowing) or single phasing (two currents flowing).

Again, at 434, this portion of the routine 400 is run when the contactor 100 is intended to be open. Here, all system voltages are present, and if any of the sensed currents are flowing, then at 444, it is determined if the auxiliary contacts (Ma) 114 are closed. If not, then, at 445, the contactor 100 is reclosed. The reason for this step is that if the contactor 100 is intended to be open, but current is still flowing and the auxiliary contacts 114 indicate that it is open, then leaving the contactor open can cause the casing of a failed vacuum interrupter to rupture and cause damage to the contactor, motor starter (not shown) and motor control center (not shown). By reclosing the contactor, the vacuum interrupter will not rupture and such damage will not occur. Since the motor starter has lost control of the load, subsequent step 450 provides the capability of opening the circuit interrupter 110 (FIG. 2). This allows the customer to change the loads onto another motor control center while limiting monetary loss. Under such a failure, although all three vacuum interrupters are not lost at once, one is lost and the other two interrupt the load. However, when the second vacuum interrupter fails, current continues to flow in two of the motor leads. This will cause the three-phase motor to be single-phased, thereby increasing the current in the two energized phases and damaging, or burning up, or otherwise destroying, the motor. This prevents failure of the vacuum interrupter envelope, which could otherwise result in unrepairable damage to the contactor 100, the motor starter (not shown), the motor control center (not shown), and/or the motor/load. By reclosing the contactor 100, the motor has all three phases energized, the currents will remain where they were before, and the motor will continue until the open circuit interrupter 110 shuts it down.

Next, at 446, a trip is declared and indicated (e.g., display “Trip-Vacuum Interrupter Failed to Open”) on the output 130 (e.g., display). Next, at 448, the event is alarmed or logged (e.g., “Trip-Vacuum Interrupter Failed to Open”) and at 450, the contactor failure relay 451 (FIG. 2) is energized before the routine 400 exits. If a corresponding circuit is configured at output 108 (as is shown in FIG. 2), then the contactor failure relay 451 causes the trip of the upstream circuit interrupter 110.

Otherwise, at 444, if the auxiliary contacts 114 are closed, then, at 452, a trip is declared and indicated (e.g., display “Trip-Contactor Failed to Open”) on the output 130 (e.g., display). This causes the cause of the failure to open or interrupt current, the time and date of the failure to open or interrupt current, the present three-phase voltages from the voltage sensors 124 and the present three-phase currents from the current sensors 126 at the time of the trip to be logged as well as a snapshot of the three-phase voltages and three-phase currents before and after the event to be stored in memory 122. For example and without limitation, these actions are done for this and other trips and/or alarm events. Next, at 454, the event is alarmed or logged (e.g., “Trip-Contactor Failed to Open”) and at 456, the contactor failure relay 451 is energized before the routine 400 exits. If the corresponding circuit is configured at output 108 (as is shown in FIG. 2), then the contactor failure relay 451 causes the trip of the upstream circuit interrupter 110.

### EXAMPLE 13

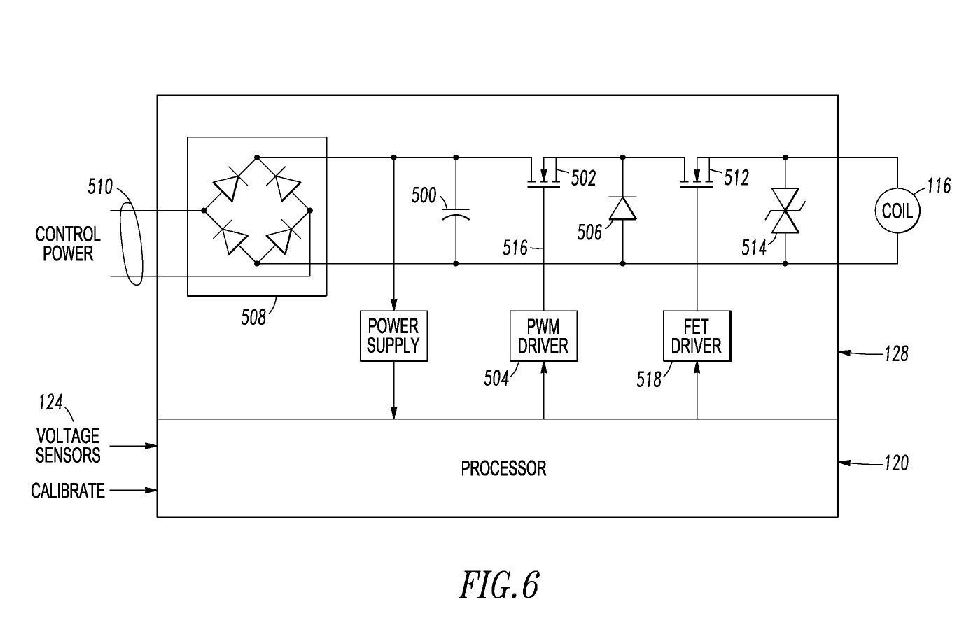

Referring to FIG. 6, the operating mechanism 104 includes the control circuit 128 and the coil 116. The processor 120 and the control circuit 128 preferably cause an immediate depletion of the back electromotive force (EMF) of the coil 116 to reduce the opening time of the separable contacts 102.

The example control circuit 128 includes a capacitor 500, a switch, such as a field effect transistor (FET) 502, and a pulse width modulated (PWM) driver 504 for driving the FET 502. When the FET 502 is turned on by the PWM driver 504, a diode 506 is reverse biased and does not conduct. On the other hand, when the FET 502 is turned off by the PWM driver 504, the back EMF of the coil 116 causes the diode 506 to be forward biased and conduct a circulating current through the coil 116 until the FET 502 starts to conduct again. This circulating current keeps the separable contacts 102 closed until the FET 502 starts to conduct again.

The example control circuit 128 also includes a suitable charging circuit, such as the example full-wave bridge 508, to charge the capacitor 500 from a control voltage 510 with sufficient energy to hold the separable contacts 102 closed and to keep the processor 120 operational for at least a predetermined time after loss of the control voltage 510. The PWM driver 504, after energizing the coil 116, during a contactor close operation, for a predetermined time, reduces the voltage to the coil 116 to a predetermined voltage, which holds the separable contacts 102 closed.

The control circuit 128 also includes a second switch, such as the example FET 512, which is electrically connected in series with the first FET 502, and a transorb 514 electrically connected in parallel with the coil 116. The processor 120 opens the separable contacts 102 by causing the second FET 512 to turn off. The turning off of FET 512 causes the back EMF of the coil 116 to be conducted through the transorb 514 at a predetermined voltage, which causes the separable contacts 102 to open after a predetermined time.

The example control voltage 510 can be, for example and without limitation, 120 VAC, 125 VDC or 240 VAC. For example, this voltage 510 preferably charges the capacitor 500 with sufficient energy to hold the contactor 100 closed and keep the processor 120 operational for about 300 milliseconds after the loss of the control voltage 510.

When the processor 120 receives a close contactor command 407 (FIG. 2), it causes the PWM driver 504 to turn on the FET 502 with a PWM signal 516 having a suitable on-time. The processor 120 also causes the FET driver 518 to turn on the second FET 512. A non-limiting example rate of the PWM signal 516 is about 1000 Hz.

Hence, the example control circuit is a pulse width modulated control circuit 128 structured to increase the applied voltage to the coil 116 responsive to the routines 200,300 of FIGS. 3 and 4 increasing the pulse width modulated on-time ratio to the pulse width modulated control circuit 128. The routines 200,300 can determine the applied voltage when, as appropriate, the auxiliary contacts 114 (FIG. 2) indicate the closed state of the separable contacts 102, or when they indicate the open state of the separable contacts 102.

The disclosed concept can verify the pick-up and drop-out voltages of the contactor coil 116, which voltages are good indicators of contactor health. By detecting failure of the contactor 100 to control the load 136, the upstream circuit interrupter 110 can open the power circuit 112, thereby preventing a downstream motor starter (not shown), motor load cables (not shown) or load (e.g., 136) from being damaged beyond repair. Under known prior proposals, knowledge of failure of a contactor or component thereof is only known if a motor overload relay calls for a trip and current continues to flow. The disclosed concept permits the cause of the contactor misoperation to be detected and displayed. This enables corrective action to be taken quickly because the cause is known and an extensive and expensive engineering investigation does not need to happen.

In, for example, a three-phase system, the disclosed concept can detect the loss of vacuum of a single vacuum interrupter (e.g., 102) and allow maintenance to be scheduled rather than waiting until a second vacuum interrupter (e.g., 102) loses vacuum and a catastrophic failure occurs (e.g., the loss of a contactor, a motor starter and/or a motor).

The disclosed concept can also detect if the contactor 100 is stuck closed (e.g., contactor armature (e.g., 17 of FIG. 1) is stuck closed; the latch assembly (e.g., 16 of FIG. 1) does not unlatch; a kick-out spring (e.g., 22 of FIG. 1) is broken; a sticky substance is between the armature plate (e.g., 6 of FIG. 1) and the coil core (e.g., 8 of FIG. 1), preventing it from opening). In each case, the contactor 100 has lost its ability to protect the load 136 and the power circuit 112 from overcurrent and failure. Hence, the contactor failure relay 451 is energized and the active output 108 causes the trip of the upstream circuit interrupter 110.

The disclosed concept can further detect and alarm failure of the separable contacts 102 and/or the auxiliary contacts 114.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A controller for a load, said controller comprising:
separable contacts;
an operating mechanism structured to open and close said separable contacts;
a processor circuit cooperating with said operating mechanism to open and close said separable contacts; and
an output controlled by said processor circuit, said output being structured to cause a remote circuit interrupter to open a power circuit electrically connected in series with said separable contacts,
wherein said processor circuit is structured to detect failure of said controller to control the load and activate said output.

2. The controller of claim 1 wherein said detected failure of said controller is failure of said controller to open or interrupt current.

3. The controller of claim 2 wherein said processor circuit comprises a processor, a memory, a first sensor structured to sense voltage operatively associated with said separable contacts and a second sensor structured to sense current flowing through said separable contacts; and wherein said processor is structured to store in said memory a cause of said failure of said controller to open or interrupt current, a time and date of said failure of said controller to open or interrupt current, a voltage applied to said separable contacts, and a current flowing through said separable contacts.

4. The controller of claim 1 wherein said operating mechanism comprises auxiliary contacts; wherein said processor circuit comprises a processor, a first sensor structured to sense voltage operatively associated with said separable contacts, a second sensor structured to sense current flowing through said separable contacts, and a routine structured to be executed by said processor whenever said separable contacts are intended to be open; and wherein said routine is structured to determine that a voltage is applied to said separable contacts, that a current is flowing through said separable contacts, that said auxiliary contacts indicate that said separable contacts are closed, and responsively activate said output.

5. The controller of claim 4 wherein said processor circuit is further structured to alarm said failure of said controller to open.

6. The controller of claim 1 wherein said operating mechanism comprises auxiliary contacts; wherein said processor circuit comprises a processor, a first sensor structured to sense voltage operatively associated with said separable contacts, a second sensor structured to sense current flowing through said separable contacts, and a routine structured to be executed by said processor whenever said separable contacts are intended to be open; and wherein said routine is structured to determine that a voltage is applied to said separable contacts, that a current is flowing through said separable contacts, that said auxiliary contacts indicate that said separable contacts are open, and responsively reclose said separable contacts and activate said output.

7. The controller of claim 6 wherein said processor circuit is further structured to alarm said failure of said controller to open, said failure being a failure of said separable contacts.

8. The controller of claim 1 wherein said failure of said controller is a failure of a component of said controller; and wherein said component of said controller is a vacuum interrupter which forms said separable contacts of said controller.

9. The controller of claim 1 wherein said controller is a medium voltage vacuum controller; and wherein said separable contacts comprise a vacuum interrupter.

10. The controller of claim 1 wherein said failure of said controller is a failure of a component of said controller; wherein said component of said controller is said operating mechanism; and wherein said operating mechanism comprises auxiliary contacts.

11. The controller of claim 10 wherein said processor circuit comprises a processor, a first sensor structured to sense voltage operatively associated with said separable contacts, a second sensor structured to sense current flowing through said separable contacts, and a routine structured to be executed by said processor whenever said separable contacts are intended to be closed; and wherein said routine is structured to determine that a voltage is applied to said separable contacts, a current is flowing through said separable contacts, said auxiliary contacts are open, and responsively indicate a failure of said auxiliary contacts.

12. The controller of claim 11 wherein said routine is further structured to be executed by said processor whenever said separable contacts are intended to be opened, and to determine that a current is not flowing through said separable contacts, said auxiliary contacts are closed, and responsively indicate a failure of said auxiliary contacts.

13. The controller of claim 10 wherein said processor circuit comprises a processor, a sensor structured to sense current flowing through said separable contacts, and a routine structured to be executed by said processor whenever said separable contacts are intended to be closed; and wherein said routine is structured to determine that a current is not flowing through said separable contacts, said auxiliary contacts are open, and responsively indicate a failure of said operating mechanism to close said separable contacts.

14. A controller comprising:
separable contacts;
an operating mechanism comprising a number of coils structured to open and close said separable contacts;
a processor cooperating with said number of coils to open and close said separable contacts;
an output controlled by said processor; and
a control circuit controlled by said processor,
wherein said control circuit is structured to cause said number of coils to open and close said separable contacts, and
wherein said processor is structured to detect failure of said separable contacts and activate said output.

15. The controller of claim 14 wherein said number of coils is a coil; wherein said operating mechanism further comprises auxiliary contacts structured to indicate an open state or a closed state of said separable contacts as controlled by said coil; wherein said processor includes a memory having a first predetermined value corresponding to a first voltage at which said coil is expected to close said separable contacts and a second predetermined value corresponding to a second voltage at which said coil is expected to open said separable contacts; wherein said control circuit is structured to apply a voltage to said coil; and wherein said processor further includes a routine structured to activate said output if the applied voltage to said coil is greater than said first predetermined value when said separable contacts are closed or if the applied voltage to said coil is greater than said second predetermined value when said separable contacts are opened.

16. The controller of claim 15 wherein said processor further includes an input; and wherein said routine is structured to be periodically executed by said processor if no voltage is applied to said separable contacts and if said input is active.

17. The controller of claim 15 wherein said control circuit is a pulse width modulated control circuit structured to increase the applied voltage responsive to said routine increasing a pulse width modulated on-time ratio to said pulse width modulated control circuit; and wherein said routine is further structured to determine the applied voltage when said auxiliary contacts indicate the closed state of said separable contacts and activate said output if the applied voltage to said coil is greater than said first predetermined value.

18. The controller of claim 15 wherein said control circuit is a pulse width modulated control circuit structured to decrease the applied voltage responsive to said routine decreasing a pulse width modulated on-time ratio to said pulse width modulated control circuit; and wherein said routine is further structured to determine the applied voltage when said auxiliary contacts indicate the open state of said separable contacts and activate said output if the applied voltage to said coil is greater than said second predetermined value.

19. The controller of claim 15 wherein the routine is a first routine; and wherein said processor further includes a second routine structured to determine said first and second predetermined values.

20. The controller of claim 19 wherein said control circuit is a pulse width modulated control circuit structured to increase the applied voltage responsive to said second routine increasing a pulse width modulated on-time ratio to said pulse width modulated control circuit; and wherein said second routine is structured to determine the applied voltage when said auxiliary contacts indicate the closed state of said separable contacts and determine said first predetermined value from said applied voltage adjusted by a third predetermined value.

21. The controller of claim 19 wherein said control circuit is a pulse width modulated control circuit structured to decrease the applied voltage responsive to said second routine decreasing a pulse width modulated on-time ratio to said pulse width modulated control circuit; and wherein said second routine is structured to determine the applied voltage when said auxiliary contacts indicate the open state of said separable contacts and determine said second predetermined value from said applied voltage adjusted by a third predetermined value.

22. The controller of claim 14 wherein said separable contacts are a number of vacuum interrupters.

23. A controller comprising:
separable contacts;
an operating mechanism comprising a coil structured to open and close said separable contacts and auxiliary contacts structured to indicate an open state or a closed state of said separable contacts;
a first sensor structured to sense voltage operatively associated with said separable contacts;
a second sensor structured to sense current flowing through said separable contacts;
a processor cooperating with said coil to open and close said separable contacts; and
an output controlled by said processor,
wherein said processor is structured to detect failure of said separable contacts or said auxiliary contacts and activate said output.

24. The controller of claim 23 wherein said processor comprises a routine structured to be executed by said processor whenever said separable contacts are intended to be closed; and wherein said routine is structured to determine from the sensed voltage that a voltage is applied to said separable contacts and from the sensed current that a current is flowing through said separable contacts, and that said auxiliary contacts indicate that said separable contacts are open, and responsively indicate at said output a failure of said auxiliary contacts.

25. The controller of claim 23 wherein said processor comprises a routine structured to be executed by said processor whenever said separable contacts are intended to be closed; and wherein said routine is structured to determine from the sensed current that a current is not flowing through said separable contacts, and that said auxiliary contacts indicate that said separable contacts are open, and responsively indicate at said output a failure to close said separable contacts.

26. The controller of claim 23 wherein said processor comprises a routine structured to be executed by said processor whenever said separable contacts are intended to be open; and wherein said routine is structured to determine from the sensed current that a current is flowing through said separable contacts, and that said auxiliary contacts indicate that said separable contacts are open, and responsively reclose said separable contacts and indicate at said output a failure to interrupt said current.

27. The controller of claim 23 wherein said processor comprises a routine structured to be executed by said processor whenever said separable contacts are intended to be open; and wherein said routine is structured to determine from the sensed current that a current is flowing through said separable contacts, and that said auxiliary contacts indicate that said separable contacts are closed, and responsively indicate at said output a failure of said operating mechanism.

28. A system for control of a load, said system comprising:
a controller comprising:
separable contacts,
an operating mechanism structured to open and close said separable contacts,
a processor cooperating with said operating mechanism to open and close said separable contacts, and
an output controlled by said processor,
wherein said processor is structured to detect failure of said controller to control said load and activate said output;
a circuit interrupter upstream of said controller and responsive to said output thereof, and
a power circuit electrically connected in series with said separable contacts,
wherein said circuit interrupter is structured to open said power circuit electrically connected in series with said separable contacts responsive to said activated output of said controller.
